(19) United States
(12) Patent Application Publication
(10) Pub. No.: US 2015/0156785 A1
(43) Pub. Date: Jun. 4, 2015

(54) METHOD FOR INTEREFERENCE CANCELLATION AND APPARATUS THEREFOR

(71) Applicant: LG ELECTRONICS INC., Seoul (KR)

(72) Inventors: Hanjun PARK, Seoul (KR); Kijun KIM, Seoul (KR); Hyungtae KIM, Seoul (KR)

(73) Assignee: LG ELECTRONICS INC.

(21) Appl. No.: 14/559,025

(22) Filed: Dec. 3, 2014

Related U.S. Application Data
(60) Provisional application No. 61/911,470, filed on Dec. 4, 2013.
(60) Provisional application No. 61/917,949, filed on Dec. 19, 2013.

(51) Int. Cl. H04W 72/08

(52) U.S. Cl. CPC H04W 72/082

(57) ABSTRACT

A method for cancelling an interference signal using interference information in a wireless communication system is performed by a User Equipment (UE) and includes receiving continuity information of an interference signal transmitted in a specific subframe, estimating a characteristic of the interference signal transmitted in the specific subframe, using the continuity information, and performing interference cancellation based on the estimated characteristic of the interference signal. The continuity information includes interference characteristic information or interference transition information at a specific frequency resource in the specific subframe.

Pursuant to 35 U.S.C. §119(e), this application claims the benefit of U.S. Provisional Patent Application Ser. No. 61/911,470, filed on Dec. 4, 2013 and 61/917,949 filed on Dec. 19, 2013, the contents of which are all hereby incorporated by reference herein in their entirety.

### BACKGROUND OF THE INVENTION

1. Field of the Invention

The present invention relates to a wireless communication system and, more particularly, to a method for interference cancellation and an apparatus therefor.

2. Discussion of the Related Art

Recently, various devices requiring machine-to-machine (M2M) communication and high data transfer rate, such as smartphones or tablet personal computers (PCs), have appeared and come into widespread use. This has rapidly increased the quantity of data which needs to be processed in a cellular network. In order to satisfy such rapidly increasing data throughput, recently, carrier aggregation (CA) technology which efficiently uses more frequency bands, cognitive ratio technology, multiple antenna (MIMO) technology for increasing data capacity in a restricted frequency, multiple-base-station cooperative technology, etc. have been highlighted. In addition, communication environments have evolved such that the density of accessible nodes is increased in the vicinity of a user equipment (UE). Here, the node includes one or more antennas and refers to a fixed point capable of transmitting/receiving radio frequency (RF) signals to/from the user equipment (UE). A communication system including high-density nodes may provide a communication service of higher performance to the UE by cooperation between nodes.

A multi-node coordinated communication scheme in which a plurality of nodes communicates with a user equipment (UE) using the same time-frequency resources has much higher data throughput than legacy communication scheme in which each node operates as an independent base station (BS) to communicate with the UE without cooperation.

A multi-node system performs coordinated communication using a plurality of nodes, each of which operates as a base station or an access point, an antenna, an antenna group, a remote radio head (RRH), and a remote radio unit (RRU). Unlike the conventional centralized antenna system in which antennas are concentrated at a base station (BS), nodes are spaced apart from each other by a predetermined distance or more in the multi-node system. The nodes can be managed by one or more base stations or base station controllers which control operations of the nodes or schedule data transmitted/received through the nodes. Each node is connected to a base station or a base station controller which manages the node through a cable or a dedicated line.

The multi-node system can be considered as a kind of Multiple Input Multiple Output (MIMO) system since dispersed nodes can communicate with a single UE or multiple UEs by simultaneously transmitting/receiving different data streams. However, since the multi-node system transmits signals using the dispersed nodes, a transmission area covered by each antenna is reduced compared to antennas included in the conventional centralized antenna system. Accordingly, transmit power required for each antenna to transmit a signal in the multi-node system can be reduced compared to the conventional centralized antenna system using MIMO. In addition, a transmission distance between an antenna and a UE is reduced to decrease in pathloss and enable rapid data transmission in the multi-node system. This can improve transmission capacity and power efficiency of a cellular system and meet communication performance having relatively uniform quality regardless of UE locations in a cell. Further, the multi-node system reduces signal loss generated during transmission since base station(s) or base station controller(s) connected to a plurality of nodes transmit/receive data in cooperation with each other. When nodes spaced apart by over a predetermined distance perform coordinated communication with a UE, correlation and interference between antennas are reduced. Therefore, a high signal to interference-plus-noise ratio (SINR) can be obtained according to the multi-node coordinated communication scheme.

Owing to the above-mentioned advantages of the multi-node system, the multi-node system is used with or replaces the conventional centralized antenna system to become a new foundation of cellular communication in order to reduce base station cost and backhaul network maintenance cost while extending service coverage and improving channel capacity and SINR in next-generation mobile communication systems.

### SUMMARY OF THE INVENTION

Accordingly, the present invention is directed to a signaling method for CoMP and an apparatus therefor which substantially obviate one or more problems due to limitations and disadvantages of the related art.

An object of the present invention is to provide a method for efficiently signaling information between eNBs for CoMP.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method for cancelling an interference signal using interference information in a wireless communication system is performed by a User Equipment (UE) and includes receiving continuity information of an interference signal transmitted in a specific subframe, estimating a characteristic of the interference signal transmitted in the specific subframe, using the continuity information, and performing interference cancellation based on the estimated characteristic of the interference signal, wherein the continuity information includes interference characteristic information or interference transition information at a specific frequency resource in the specific subframe.

Additionally or alternatively, the interference characteristic information may indicate characteristic of the interference signal at the specific frequency resource in the specific subframe.

Additionally or alternatively, the interference characteristic information may indicate whether or not the interference signal is present, a Reference Signal (RS) type, or whether transmit diversity is used for the interference signal at the specific frequency resource in the specific subframe.

Additionally or alternatively, the interference transition information may indicate information about transition in interference characteristic between two contiguous frequency resources in the specific subframe.

Additionally or alternatively, the interference transition information may indicate information about whether RS types of interference signals present in two contiguous frequency resources in the specific subframe are the same, whether precoding matrices of the interference signals are the same, or whether the interference signals correspond to the same Physical Downlink Shared Channel (PDSCH).

Additionally or alternatively, if a (k−1)-th frequency resource in the specific subframe does not have continuity information or indicates specific continuity information, the continuity information corresponding to a k-th frequency resource in the specific subframe may indicate the interference characteristic information, and, if the (k−1)-th frequency resource in the specific subframe has continuity information and indicates specific continuity information, the continuity information corresponding to the k-th frequency resource in the specific subframe may indicate the interference transition information.

Additionally or alternatively, the continuity information may be represented using n bits to indicate one of 2ⁿ interference characteristic information states or 2ⁿ interference transition information states.

Additionally or alternatively, the method may further include receiving additional characteristic information of the interference signal in addition to the continuity information, and the additional characteristic information may be provided for p frequency resources determined as having the same estimated interference characteristic based on the continuity information.

In another aspect of the present invention, a User Equipment (UE) configured to cancel an interference signal using interference information in a wireless communication system includes a Radio Frequency (RF) unit, and a processor configured to control the RF unit, wherein the processor is configured to receive continuity information of an interference signal transmitted in a specific subframe, estimate a characteristic of the interference signal transmitted in the specific subframe, using the continuity information, and perform interference cancellation based on the estimated characteristic of the interference signal, and wherein the continuity information includes interference characteristic information or interference transition information at a specific frequency resource in the specific subframe.

Additionally or alternatively, the interference characteristic information may indicate characteristic of the interference signal at the specific frequency resource in the specific subframe.

Additionally or alternatively, the interference characteristic information may indicate whether or not the interference signal is present, a Reference Signal (RS) type, or whether transmit diversity is used for the interference signal at the specific frequency resource in the specific subframe.

Additionally or alternatively, the interference transition information may indicate information about transition in interference characteristic between two contiguous frequency resources in the specific subframe.

Additionally or alternatively, the interference transition information may indicate information about whether RS types of interference signals present in two contiguous frequency resources in the specific subframe are the same, whether precoding matrices of the interference signals are the same, or whether the interference signals correspond to the same Physical Downlink Shared Channel (PDSCH).

Additionally or alternatively, if a (k−1)-th frequency resource in the specific subframe does not have continuity information or indicates specific continuity information, the continuity information corresponding to a k-th frequency resource in the specific subframe may indicate the interference characteristic information, and, if the (k−1)-th frequency resource in the specific subframe has continuity information and indicates specific continuity information, the continuity information corresponding to the k-th frequency resource in the specific subframe may indicate the interference transition information.

Additionally or alternatively, the continuity information may be represented using n bits to indicate one of 2ⁿ interference characteristic information states or 2ⁿ interference transition information states.

Additionally or alternatively, the processor may be further configured to receive additional characteristic information of the interference signal in addition to the continuity information, and the additional characteristic information may be provided for p frequency resources determined as having the same estimated interference characteristic based on the continuity information.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1(a) to FIG. 1(b) illustrate an exemplary radio frame structure in a wireless communication system;

FIG. 2 illustrates an exemplary structure of a Downlink/Uplink (DL/UL) slot in a wireless communication system;

FIG. 3 illustrates an exemplary structure of a DL subframe in a 3rd Generation Partnership project (3GPP) Long Term Evolution (LTE)/LTE-Advanced (LTE-A) system;

FIG. 4 illustrates an exemplary structure of a UL subframe in the 3GPP LTE/LTE-A system;

FIG. 5 illustrates an interference environment in a multi-cell environment;

FIG. 6 shows characteristics of an interference signal estimated based on continuity information according to an embodiment of the present invention, and real interference characteristics;

FIG. 7 shows characteristics of an interference signal estimated based on continuity information according to another embodiment of the present invention, and real interference characteristics;

FIG. 8 shows characteristics of an interference signal estimated based on continuity information according to another embodiment of the present invention, and real interference characteristics;

FIG. 9 shows characteristics of an interference signal estimated based on continuity information according to another embodiment of the present invention, and real interference characteristics; and

FIG. 10 is a block diagram of apparatuses for implementing an embodiment(s) of the present invention.

### DETAILED DESCRIPTION OF THE INVENTION

Reference will now be made in detail to the preferred embodiments of the present invention, examples of which are illustrated in the accompanying drawings. The accompanying drawings illustrate exemplary embodiments of the present invention and provide a more detailed description of the present invention. However, the scope of the present invention should not be limited thereto.

In some cases, to prevent the concept of the present invention from being ambiguous, structures and apparatuses of the known art will be omitted, or will be shown in the form of a block diagram based on main functions of each structure and apparatus. Also, wherever possible, the same reference numbers will be used throughout the drawings and the specification to refer to the same or like parts.

In the present invention, a user equipment (UE) is fixed or mobile. The UE is a device that transmits and receives user data and/or control information by communicating with a base station (BS). The term ‘UE’ may be replaced with ‘terminal equipment’, ‘Mobile Station (MS)’, ‘Mobile Terminal (MT)’, ‘User Terminal (UT)’, ‘Subscriber Station (SS)’, ‘wireless device’, ‘Personal Digital Assistant (PDA)’, ‘wireless modem’, ‘handheld device’, etc. A BS is typically a fixed station that communicates with a UE and/or another BS. The BS exchanges data and control information with a UE and another BS. The term ‘BS’ may be replaced with ‘Advanced Base Station (ABS)’, ‘Node B’, ‘evolved-Node B (eNB)’, ‘Base Transceiver System (BTS)’, ‘Access Point (AP)’, ‘Processing Server (PS)’, etc. In the following description, BS is commonly called eNB.

In the present invention, a node refers to a fixed point capable of transmitting/receiving a radio signal to/from a UE by communication with the UE. Various eNBs can be used as nodes. For example, a node can be a BS, NB, eNB, pico-cell eNB (PeNB), home eNB (HeNB), relay, repeater, etc. Furthermore, a node may not be an eNB. For example, a node can be a radio remote head (RRH) or a radio remote unit (RRU). The RRH and RRU have power levels lower than that of the eNB. Since the RRH or RRU (referred to as RRH/RRU hereinafter) is connected to an eNB through a dedicated line such as an optical cable in general, cooperative communication according to RRH/RRU and eNB can be smoothly performed compared to cooperative communication according to eNBs connected through a wireless link. At least one antenna is installed per node. An antenna may refer to an antenna port, a virtual antenna or an antenna group. A node may also be called a point. Unlink a conventional centralized antenna system (CAS) (i.e. single node system) in which antennas are concentrated in an eNB and controlled an eNB controller, plural nodes are spaced apart at a predetermined distance or longer in a multi-node system. The plural nodes can be managed by one or more eNBs or eNB controllers that control operations of the nodes or schedule data to be transmitted/received through the nodes. Each node may be connected to an eNB or eNB controller managing the corresponding node via a cable or a dedicated line. In the multi-node system, the same cell identity (ID) or different cell IDs may be used for signal transmission/reception through plural nodes. When plural nodes have the same cell ID, each of the plural nodes operates as an antenna group of a cell. If nodes have different cell IDs in the multi-node system, the multi-node system can be regarded as a multi-cell (e.g. macro-cell/femto-cell/pico-cell) system. When multiple cells respectively configured by plural nodes are overlaid according to coverage, a network configured by multiple cells is called a multi-tier network. The cell ID of the RRH/RRU may be identical to or different from the cell ID of an eNB. When the RRH/RRU and eNB use different cell IDs, both the RRH/RRU and eNB operate as independent eNBs.

In a multi-node system according to the present invention, which will be described below, one or more eNBs or eNB controllers connected to plural nodes can control the plural nodes such that signals are simultaneously transmitted to or received from a UE through some or all nodes. While there is a difference between multi-node systems according to the nature of each node and implementation form of each node, multi-node systems are discriminated from single node systems (e.g. CAS, conventional MIMO systems, conventional relay systems, conventional repeater systems, etc.) since a plurality of nodes provides communication services to a UE in a predetermined time-frequency resource. Accordingly, embodiments of the present invention with respect to a method of performing coordinated data transmission using some or all nodes can be applied to various types of multi-node systems. For example, a node refers to an antenna group spaced apart from another node by a predetermined distance or more, in general. However, embodiments of the present invention, which will be described below, can even be applied to a case in which a node refers to an arbitrary antenna group irrespective of node interval. In the case of an eNB including an X-pole (cross polarized) antenna, for example, the embodiments of the preset invention are applicable on the assumption that the eNB controls a node composed of an H-pole antenna and a V-pole antenna.

A communication scheme through which signals are transmitted/received via plural transmit (Tx)/receive (Rx) nodes, signals are transmitted/received via at least one node selected from plural Tx/Rx nodes, or a node transmitting a downlink signal is discriminated from a node transmitting an uplink signal is called multi-eNB MIMO or CoMP (Coordinated Multi-Point Tx/Rx). Coordinated transmission schemes from among CoMP communication schemes can be categorized into JP (Joint Processing) and scheduling coordination. The former may be divided into JT (Joint Transmission)/JR (Joint Reception) and DPS (Dynamic Point Selection) and the latter may be divided into CS (Coordinated Scheduling) and CB (Coordinated Beamforming) DPS may be called DCS (Dynamic Cell Selection). When JP is performed, more various communication environments can be generated, compared to other CoMP schemes. JT refers to a communication scheme by which plural nodes transmit the same stream to a UE and JR refers to a communication scheme by which plural nodes receive the same stream from the UE. The UE/eNB combine signals received from the plural nodes to restore the stream. In the case of JT/JR, signal transmission reliability can be improved according to transmit diversity since the same stream is transmitted from/to plural nodes. DPS refers to a communication scheme by which a signal is transmitted/received through a node selected from plural nodes according to a specific rule. In the case of DPS, signal transmission reliability can be improved because a node having a good channel state between the node and a UE is selected as a communication node.

In the present invention, a cell refers to a specific geographical area in which one or more nodes provide communication services. Accordingly, communication with a specific cell may mean communication with an eNB or a node providing communication services to the specific cell. A downlink/uplink signal of a specific cell refers to a downlink/uplink signal from/to an eNB or a node providing communication services to the specific cell. A cell providing uplink/downlink communication services to a UE is called a serving cell. Furthermore, channel status/quality of a specific cell refers to channel status/quality of a channel or a communication link generated between an eNB or a node providing communication services to the specific cell and a UE. In 3GPP LTE-A systems, a UE can measure downlink channel state from a specific node using one or more CSI-RSs (Channel State Information Reference Signals) transmitted through antenna port(s) of the specific node on a CSI-RS resource allocated to the specific node. In general, neighboring nodes transmit CSI-RS resources on orthogonal CSI-RS resources. When CSI-RS resources are orthogonal, this means that the CSI-RS resources have different subframe configurations and/or CSI-RS sequences which specify subframes to which CSI-RSs are allocated according to CSI-RS resource configurations, subframe offsets and transmission periods, etc. which specify symbols and subcarriers carrying the CSI RSs.

In the present invention, PDCCH (Physical Downlink Control Channel)/PCFICH (Physical Control Format Indicator Channel)/PHICH (Physical Hybrid automatic repeat request Indicator Channel)/PDSCH (Physical Downlink Shared Channel) refer to a set of time-frequency resources or resource elements respectively carrying DCI (Downlink Control Information)/CFI (Control Format Indicator)/downlink ACK/NACK (Acknowlegement/Negative ACK)/downlink data. In addition, PUCCH (Physical Uplink Control Channel)/PUSCH (Physical Uplink Shared Channel)/PRACH (Physical Random Access Channel) refer to sets of time-frequency resources or resource elements respectively carrying UCI (Uplink Control Information)/uplink data/random access signals. In the present invention, a time-frequency resource or a resource element (RE), which is allocated to or belongs to PDCCH/PCFICH/PHICH/PDSCH/PUCCH/PUSCH/PRACH, is referred to as a PDCCH/PCFICH/PHICH/PDSCH/PUCCH/PUSCH/PRACH RE or PDCCH/PCFICH/PHICH/PDSCH/PUCCH/PUSCH/PRACH resource. In the following description, transmission of PUCCH/PUSCH/PRACH by a UE is equivalent to transmission of uplink control information/uplink data/random access signal through or on PUCCH/PUSCH/PRACH. Furthermore, transmission of PDCCH/PCFICH/PHICH/PDSCH by an eNB is equivalent to transmission of downlink data/control information through or on PDCCH/PCFICH/PHICH/PDSCH.

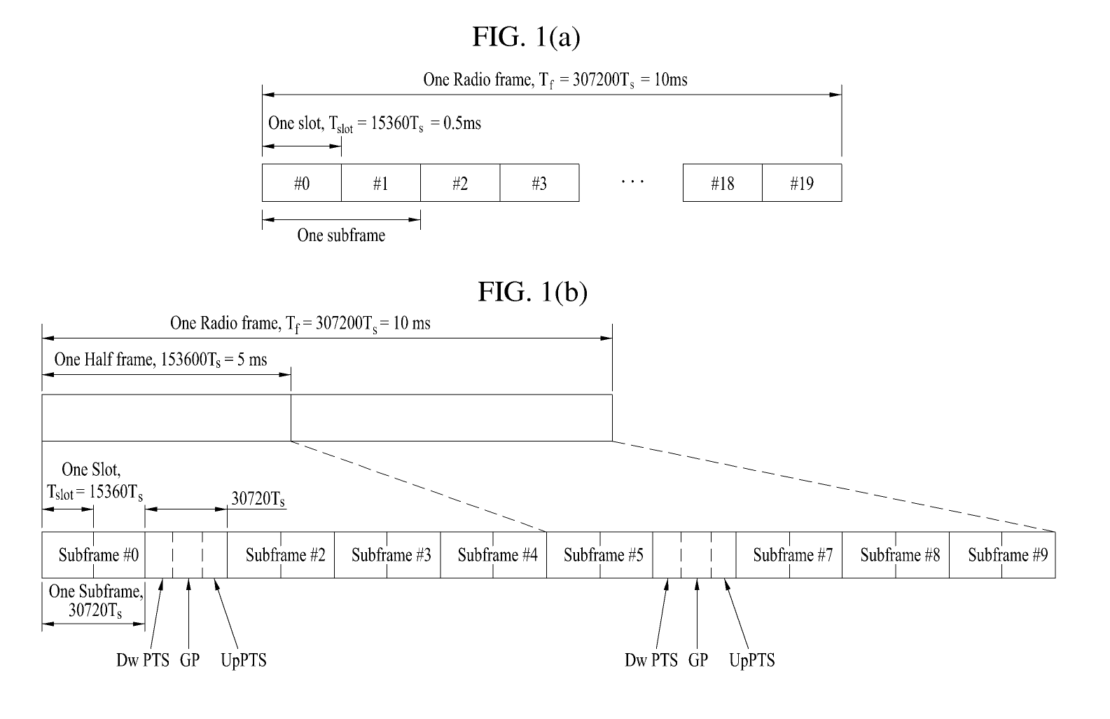

FIG. 1 illustrates an exemplary radio frame structure used in a wireless communication system. FIG. 1(a) illustrates a frame structure for frequency division duplex (FDD) used in 3GPP LTE/LTE-A and FIG. 1(b) illustrates a frame structure for time division duplex (TDD) used in 3GPP LTE/LTE-A.

Referring to FIG. 1, a radio frame used in 3GPP LTE/LTE-A has a length of 10 ms (307200 Ts) and includes 10 subframes in equal size. The 10 subframes in the radio frame may be numbered. Here, Ts denotes sampling time and is represented as Ts=1/(2048*15 kHz). Each subframe has a length of 1 ms and includes two slots. 20 slots in the radio frame can be sequentially numbered from 0 to 19. Each slot has a length of 0.5 ms. A time for transmitting a subframe is defined as a transmission time interval (TTI). Time resources can be discriminated by a radio frame number (or radio frame index), subframe number (or subframe index) and a slot number (or slot index).

The radio frame can be configured differently according to duplex mode. Downlink transmission is discriminated from uplink transmission by frequency in FDD mode, and thus the radio frame includes only one of a downlink subframe and an uplink subframe in a specific frequency band. In TDD mode, downlink transmission is discriminated from uplink transmission by time, and thus the radio frame includes both a downlink subframe and an uplink subframe in a specific frequency band.

Table 1 shows DL-UL configurations of subframes in a radio frame in the TDD mode.

TABLE 1

| | Downlink- | | | | | | | | | | |
|---|---|---|---|---|---|---|---|---|---|---|---|
| DL-UL | to-Uplink | | | | | | | | | | |
| config- | Switch-point | Subframe number | | | | | | | | | |
| uration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

In Table 1, D denotes a downlink subframe, U denotes an uplink subframe and S denotes a special subframe. The special subframe includes three fields of DwPTS (Downlink Pilot TimeSlot), GP (Guard Period), and UpPTS (Uplink Pilot TimeSlot). DwPTS is a period reserved for downlink transmission and UpPTS is a period reserved for uplink transmission. Table 2 shows special subframe configuration.

TABLE 2

| | Normal cyclic prefix in downlink | | | Extended cyclic prefix in downlink | | |
|---|---|---|---|---|---|---|
| | | UpPTS | | | UpPTS | |
| | | Normal | Extended | | Normal | Extended |
| Special subframe | | cyclic prefix | cyclic prefix | | cyclic prefix | cyclic prefix |
| configuration | DwPTS | in uplink | in uplink | DwPTS | in uplink | in uplink |
| 0 | 6592 · Tₛ | 2192 · Tₛ | 2560 · Tₛ | 7680 · Tₛ | 2192 · Tₛ | 2560 · Tₛ |
| 1 | 19760 · Tₛ | | | 20480 · Tₛ | | |
| 2 | 21952 · Tₛ | | | 23040 · Tₛ | | |
| 3 | 24144 · Tₛ | | | 25600 · Tₛ | | |
| 4 | 26336 · Tₛ | | | 7680 · Tₛ | 4384 · Tₛ | 5120 · Tₛ |
| 5 | 6592 · Tₛ | 4384 · Tₛ | 5120 · Tₛ | 20480 · Tₛ | | |
| 6 | 19760 · Tₛ | | | 23040 · Tₛ | | |
| 7 | 21952 · Tₛ | | | 12800 · Tₛ | | |
| 8 | 24144 · Tₛ | | | — | — | — |
| 9 | 13168 · Tₛ | | | — | — | — |

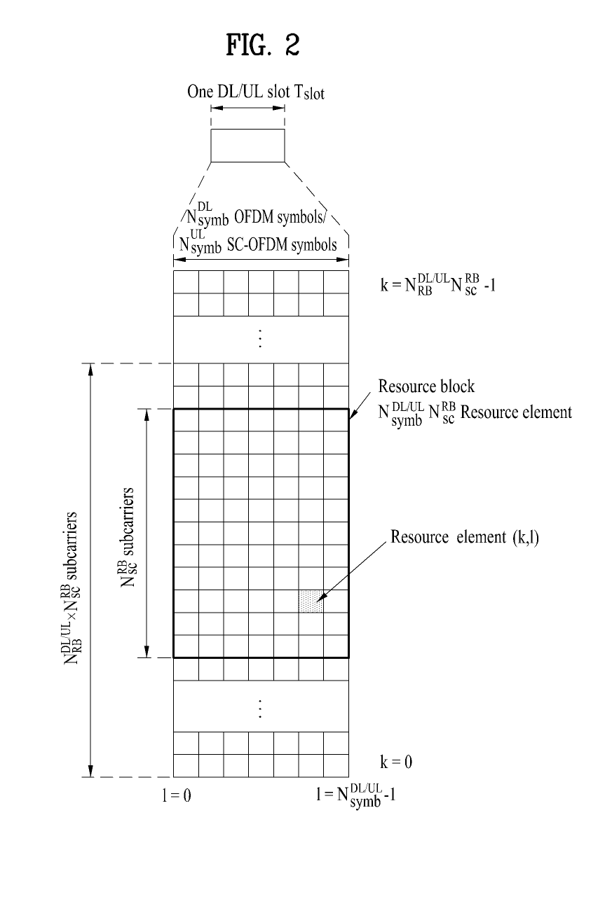

FIG. 2 illustrates an exemplary downlink/uplink slot structure in a wireless communication system. Particularly, FIG. 2 illustrates a resource grid structure in 3GPP LTE/LTE-A. A resource grid is present per antenna port.

Referring to FIG. 2, a slot includes a plurality of OFDM (Orthogonal Frequency Division Multiplexing) symbols in the time domain and a plurality of resource blocks (RBs) in the frequency domain. An OFDM symbol may refer to a symbol period. A signal transmitted in each slot may be represented by a resource grid composed of N_{RB}^{DL/UL}*N_{sc}^{RB} subcarriers and N_{symb}^{DL/UL} OFDM symbols. Here, RB denotes the number of RBs in a downlink slot and N_{RB}^{UL} denotes the number of RBs in an uplink slot. N_{RB}^{UL} and N_{RB}^{UL} respectively depend on a DL transmission bandwidth and a UL transmission bandwidth. N_{symb}^{DL} denotes the number of OFDM symbols in the downlink slot and N_{symb}^{UL} denotes the number of OFDM symbols in the uplink slot. In addition, N_{sc}^{RB} denotes the number of subcarriers constructing one RB.

An OFDM symbol may be called an SC-FDM (Single Carrier Frequency Division Multiplexing) symbol according to multiple access scheme. The number of OFDM symbols included in a slot may depend on a channel bandwidth and the length of a cyclic prefix (CP). For example, a slot includes 7 OFDM symbols in the case of normal CP and 6 OFDM symbols in the case of extended CP. While FIG. 2 illustrates a subframe in which a slot includes 7 OFDM symbols for convenience, embodiments of the present invention can be equally applied to subframes having different numbers of OFDM symbols. Referring to FIG. 2, each OFDM symbol includes N_{RB}^{DL/UL}*N_{sc}^{RB} subcarriers in the frequency domain. Subcarrier types can be classified into a data subcarrier for data transmission, a reference signal subcarrier for reference signal transmission, and null subcarriers for a guard band and a direct current (DC) component. The null subcarrier for a DC component is a subcarrier remaining unused and is mapped to a carrier frequency (f0) during OFDM signal generation or frequency up-conversion. The carrier frequency is also called a center frequency.

An RB is defined by N_{symb}^{DL/UL} (e.g. 7) consecutive OFDM symbols in the time domain and N_{sc}^{RB} (e.g. 12) consecutive subcarriers in the frequency domain. For reference, a resource composed by an OFDM symbol and a subcarrier is called a resource element (RE) or a tone. Accordingly, an RB is composed of N_{symb}^{DL/UL}*N_{sc}^{RB} REs. Each RE in a resource grid can be uniquely defined by an index pair (k, l) in a slot. Here, k is an index in the range of 0 to N_{symb}^{DL/UL}*N_{sc}^{RB}−1 in the frequency domain and l is an index in the range of 0 to N_{symb}^{DL/UL}−1.

Two RBs that occupy N_{sc}^{RB} consecutive subcarriers in a subframe and respectively disposed in two slots of the subframe are called a physical resource block (PRB) pair. Two RBs constituting a PRB pair have the same PRB number (or PRB index). A virtual resource block (VRB) is a logical resource allocation unit for resource allocation. The VRB has the same size as that of the PRB. The VRB may be divided into a localized VRB and a distributed VRB depending on a mapping scheme of VRB into PRB. The localized VRBs are mapped into the PRBs, whereby VRB number (VRB index) corresponds to PRB number. That is, nPRB=nVRB is obtained. Numbers are given to the localized VRBs from 0 to N_{VRB}^{DL}−1, and N_{VRB}^{DL}=N_{RB}^{DL} is obtained. Accordingly, according to the localized mapping scheme, the VRBs having the same VRB number are mapped into the PRBs having the same PRB number at the first slot and the second slot. On the other hand, the distributed VRBs are mapped into the PRBs through interleaving. Accordingly, the VRBs having the same VRB number may be mapped into the PRBs having different PRB numbers at the first slot and the second slot. Two PRBs, which are respectively located at two slots of the subframe and have the same VRB number, will be referred to as a pair of VRBs.

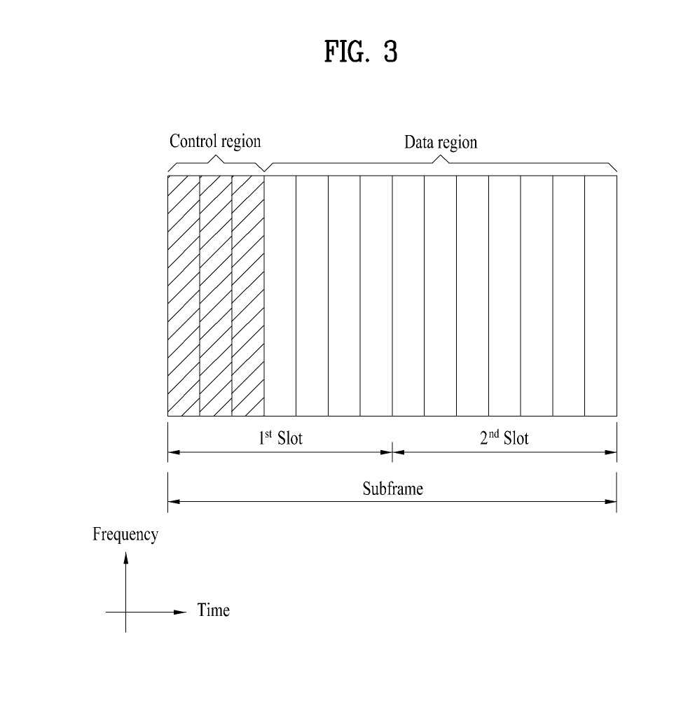

FIG. 3 illustrates a downlink (DL) subframe structure used in 3GPP LTE/LTE-A.

Referring to FIG. 3, a DL subframe is divided into a control region and a data region. A maximum of three (four) OFDM symbols located in a front portion of a first slot within a subframe correspond to the control region to which a control channel is allocated. A resource region available for PDCCH transmission in the DL subframe is referred to as a PDCCH region hereinafter. The remaining OFDM symbols correspond to the data region to which a physical downlink shared chancel (PDSCH) is allocated. A resource region available for PDSCH transmission in the DL subframe is referred to as a PDSCH region hereinafter. Examples of downlink control channels used in 3GPP LTE include a physical control format indicator channel (PCFICH), a physical downlink control channel (PDCCH), a physical hybrid ARQ indicator channel (PHICH), etc. The PCFICH is transmitted at a first OFDM symbol of a subframe and carries information regarding the number of OFDM symbols used for transmission of control channels within the subframe. The PHICH is a response of uplink transmission and carries an HARQ acknowledgment (ACK)/negative acknowledgment (NACK) signal.

Control information carried on the PDCCH is called downlink control information (DCI). The DCI contains resource allocation information and control information for a UE or a UE group. For example, the DCI includes a transport format and resource allocation information of a downlink shared channel (DL-SCH), a transport format and resource allocation information of an uplink shared channel (UL-SCH), paging information of a paging channel (PCH), system information on the DL-SCH, information about resource allocation of an upper layer control message such as a random access response transmitted on the PDSCH, a transmit control command set with respect to individual UEs in a UE group, a transmit power control command, information on activation of a voice over IP (VoIP), downlink assignment index (DAI), etc. The transport format and resource allocation information of the DL-SCH are also called DL scheduling information or a DL grant and the transport format and resource allocation information of the UL-SCH are also called UL scheduling information or a UL grant. The size and purpose of DCI carried on a PDCCH depend on DCI format and the size thereof may be varied according to coding rate. Various formats, for example, formats 0 and 4 for uplink and formats 1, 1A, 1B, 1C, 1D, 2, 2A, 2B, 2C, 3 and 3A for downlink, have been defined in 3GPP LTE. Control information such as a hopping flag, information on RB allocation, modulation coding scheme (MCS), redundancy version (RV), new data indicator (NDI), information on transmit power control (TPC), cyclic shift demodulation reference signal (DMRS), UL index, channel quality information (CQI) request, DL assignment index, HARQ process number, transmitted precoding matrix indicator (TPMI), precoding matrix indicator (PMI), etc. is selected and combined based on DCI format and transmitted to a UE as DCI.

In general, a DCI format for a UE depends on transmission mode (TM) set for the UE. In other words, only a DCI format corresponding to a specific TM can be used for a UE configured in the specific TM.

A PDCCH is transmitted on an aggregation of one or several consecutive control channel elements (CCEs). The CCE is a logical allocation unit used to provide the PDCCH with a coding rate based on a state of a radio channel. The CCE corresponds to a plurality of resource element groups (REGs). For example, a CCE corresponds to 9 REGs and an REG corresponds to 4 REs. 3GPP LTE defines a CCE set in which a PDCCH can be located for each UE. A CCE set from which a UE can detect a PDCCH thereof is called a PDCCH search space, simply, search space. An individual resource through which the PDCCH can be transmitted within the search space is called a PDCCH candidate. A set of PDCCH candidates to be monitored by the UE is defined as the search space. In 3GPP LTE/LTE-A, search spaces for DCI formats may have different sizes and include a dedicated search space and a common search space. The dedicated search space is a UE-specific search space and is configured for each UE. The common search space is configured for a plurality of UEs. Aggregation levels defining the search space is as follows.

TABLE 3

| Search Space | | | |
|---|---|---|---|
| | Aggregation | | Number of |
| | Level | Size | PDCCH |
| Type | L | [in CCEs] | candidates M^{(L)} |
| UE-specific | 1 | 6 | 6 |
| | 2 | 12 | 6 |
| | 4 | 8 | 2 |
| | 8 | 16 | 2 |
| Common | 4 | 16 | 4 |
| | 8 | 16 | 2 |

A PDCCH candidate corresponds to 1, 2, 4 or 8 CCEs according to CCE aggregation level. An eNB transmits a PDCCH (DCI) on an arbitrary PDCCH candidate with in a search space and a UE monitors the search space to detect the PDCCH (DCI). Here, monitoring refers to attempting to decode each PDCCH in the corresponding search space according to all monitored DCI formats. The UE can detect the PDCCH thereof by monitoring plural PDCCHs. Since the UE does not know the position in which the PDCCH thereof is transmitted, the UE attempts to decode all PDCCHs of the corresponding DCI format for each subframe until a PDCCH having the ID thereof is detected. This process is called blind detection (or blind decoding (BD)).

The eNB can transmit data for a UE or a UE group through the data region. Data transmitted through the data region may be called user data. For transmission of the user data, a physical downlink shared channel (PDSCH) may be allocated to the data region. A paging channel (PCH) and downlink-shared channel (DL-SCH) are transmitted through the PDSCH. The UE can read data transmitted through the PDSCH by decoding control information transmitted through a PDCCH. Information representing a UE or a UE group to which data on the PDSCH is transmitted, how the UE or UE group receives and decodes the PDSCH data, etc. is included in the PDCCH and transmitted. For example, if a specific PDCCH is CRC (cyclic redundancy check)-masked having radio network temporary identify (RNTI) of “A” and information about data transmitted using a radio resource (e.g. frequency position) of “B” and transmission format information (e.g. transport block size, modulation scheme, coding information, etc.) of “C” is transmitted through a specific DL subframe, the UE monitors PDCCHs using RNTI information and a UE having the RNTI of “A” detects a PDCCH and receives a PDSCH indicated by “B” and “C” using information about the PDCCH.

A reference signal (RS) to be compared with a data signal is necessary for the UE to demodulate a signal received from the eNB. A reference signal refers to a predetermined signal having a specific waveform, which is transmitted from the eNB to the UE or from the UE to the eNB and known to both the eNB and UE. The reference signal is also called a pilot. Reference signals are categorized into a cell-specific RS shared by all UEs in a cell and a modulation RS (DM RS) dedicated for a specific UE. A DM RS transmitted by the eNB for demodulation of downlink data for a specific UE is called a UE-specific RS. Both or one of DM RS and CRS may be transmitted on downlink. When only the DM RS is transmitted without CRS, an RS for channel measurement needs to be additionally provided because the DM RS transmitted using the same precoder as used for data can be used for demodulation only. For example, in 3GPP LTE(-A), CSI-RS corresponding to an additional RS for measurement is transmitted to the UE such that the UE can measure channel state information. CSI-RS is transmitted in each transmission period corresponding to a plurality of subframes based on the fact that channel state variation with time is not large, unlike CRS transmitted per subframe.

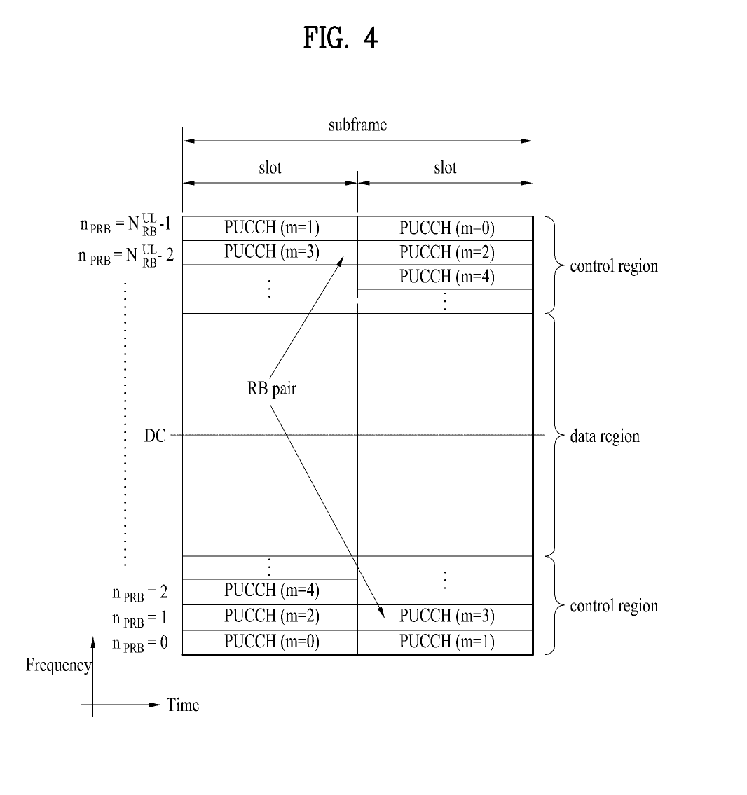

FIG. 4 illustrates an exemplary uplink subframe structure used in 3GPP LTE/LTE-A.

Referring to FIG. 4, a UL subframe can be divided into a control region and a data region in the frequency domain. One or more PUCCHs (physical uplink control channels) can be allocated to the control region to carry uplink control information (UCI). One or more PUSCHs (Physical uplink shared channels) may be allocated to the data region of the UL subframe to carry user data.

In the UL subframe, subcarriers spaced apart from a DC subcarrier are used as the control region. In other words, subcarriers corresponding to both ends of a UL transmission bandwidth are assigned to UCI transmission. The DC subcarrier is a component remaining unused for signal transmission and is mapped to the carrier frequency f0 during frequency up-conversion. A PUCCH for a UE is allocated to an RB pair belonging to resources operating at a carrier frequency and RBs belonging to the RB pair occupy different subcarriers in two slots. Assignment of the PUCCH in this manner is represented as frequency hopping of an RB pair allocated to the PUCCH at a slot boundary. When frequency hopping is not applied, the RB pair occupies the same subcarrier.

The PUCCH can be used to transmit the following control information.
Scheduling Request (SR): This is information used to request a UL-SCH resource and is transmitted using On-Off Keying (OOK) scheme.
HARQ ACK/NACK: This is a response signal to a downlink data packet on a PDSCH and indicates whether the downlink data packet has been successfully received. A 1-bit ACK/NACK signal is transmitted as a response to a single downlink codeword and a 2-bit ACK/NACK signal is transmitted as a response to two downlink codewords. HARQ-ACK responses include positive ACK (ACK), negative ACK (NACK), discontinuous transmission (DTX) and NACK/DTX. Here, the term HARQ-ACK is used interchangeably with the term HARQ ACK/NACK and ACK/NACK.
Channel State Indicator (CSI): This is feedback information about a downlink channel. Feedback information regarding MIMO includes a rank indicator (RI) and a precoding matrix indicator (PMI).

The quantity of control information (UCI) that a UE can transmit through a subframe depends on the number of SC-FDMA symbols available for control information transmission. The SC-FDMA symbols available for control information transmission correspond to SC-FDMA symbols other than SC-FDMA symbols of the subframe, which are used for reference signal transmission. In the case of a subframe in which a sounding reference signal (SRS) is configured, the last SC-FDMA symbol of the subframe is excluded from the SC-FDMA symbols available for control information transmission. A reference signal is used to detect coherence of the PUCCH. The PUCCH supports various formats according to information transmitted thereon. Table 4 shows the mapping relationship between PUCCH formats and UCI in LTE/LTE-A.

TABLE 4

| | | Number of | | |
|---|---|---|---|---|
| | | bits per | | |
| PUCCH | Modulation | subframe, | | |
| format | scheme | M_{bit} | Usage | Etc. |
| 1 | N/A | N/A | SR (Scheduling | |
| | | | Request) | |
| 1a | BPSK | 1 | ACK/NACK or | One codeword |
| | | | SR + ACK/NACK | |
| 1b | QPSK | 2 | ACK/NACK or | Two codeword |
| | | | SR + ACK/NACK | |
| 2 | QPSK | 20 | CQI/PMI/RI | Joint coding |
| | | | | ACK/NACK |
| | | | | (extended |
| | | | | CP) |
| 2a | QPSK + | 21 | CQI/PMI/RI + | Normal CP |
| | BPSK | | ACK/NACK | only |
| 2b | QPSK + | 22 | CQI/PMI/RI + | Normal CP |
| | QPSK | | ACK/NACK | only |
| 3 | QPSK | 48 | ACK/NACK or | |
| | | | SR + ACK/NACK | |
| | | | or | |
| | | | CQI/PMI/RI + | |
| | | | ACK/NACK | |

Referring to Table 4, PUCCH formats 1/1a/1b are used to transmit ACK/NACK information, PUCCH format 2/2a/2b are used to carry CSI such as CQI/PMI/RI and PUCCH format 3 is used to transmit ACK/NACK information.

Reference Signal (RS)

When a packet is transmitted in a wireless communication system, signal distortion may occur during transmission since the packet is transmitted through a radio channel. To correctly receive a distorted signal at a receiver, the distorted signal needs to be corrected using channel information. To detect channel information, a signal known to both a transmitter and the receiver is transmitted and channel information is detected with a degree of distortion of the signal when the signal is received through a channel. This signal is called a pilot signal or a reference signal.

When data is transmitted/received using multiple antennas, the receiver can receive a correct signal only when the receiver is aware of a channel state between each transmit antenna and each receive antenna. Accordingly, a reference signal needs to be provided per transmit antenna, more specifically, per antenna port.

Reference signals can be classified into an uplink reference signal and a downlink reference signal. In LTE, the uplink reference signal includes:

i) a demodulation reference signal (DMRS) for channel estimation for coherent demodulation of information transmitted through a PUSCH and a PUCCH; and

ii) a sounding reference signal (SRS) used for an eNB to measure uplink channel quality at a frequency of a different network.

The downlink reference signal includes:

i) a cell-specific reference signal (CRS) shared by all UEs in a cell;

ii) a UE-specific reference signal for a specific UE only;

iii) a DMRS transmitted for coherent demodulation when a PDSCH is transmitted;

iv) a channel state information reference signal (CSI-RS) for delivering channel state information (CSI) when a downlink DMRS is transmitted;

v) a multimedia broadcast single frequency network (MBSFN) reference signal transmitted for coherent demodulation of a signal transmitted in MBSFN mode; and

vi) a positioning reference signal used to estimate geographic position information of a UE.

Reference signals can be classified into a reference signal for channel information acquisition and a reference signal for data demodulation. The former needs to be transmitted in a wide band as it is used for a UE to acquire channel information on downlink transmission and received by a UE even if the UE does not receive downlink data in a specific subframe. This reference signal is used even in a handover situation. The latter is transmitted along with a corresponding resource by an eNB when the eNB transmits a downlink signal and is used for a UE to demodulate data through channel measurement. This reference signal needs to be transmitted in a region in which data is transmitted.

PRB Bundling

PRB bundling refers to application of the same PMI over a plurality of contiguous Resource Blocks (RBs) in data transmission, and the size of RBs to which the same PMI is applied is determined according to an available frequency range.

In detail, when PMI/RI feedback is configured, a UE can assume that a precoding granularity corresponds to a plurality of RBs in the frequency domain. Precoding RB Groups (PRGs) dependent upon a fixed system bandwidth of size P′ divide the system bandwidth and each PRG is composed of contiguous PRBs. If N_{RB}^{DL} mod P′ is greater than 0, one of the PRGs has a size of N_{RB}^{DL}−P′└N_{RB}^{DL}/P′┘. The PRG sizes are not arranged in ascending order from the lowest frequency. The UE can assume that the same precoder is applied to all scheduled PRBs within the PRG.

The PRG size assumable by the UE for a given system bandwidth is as shown below.

TABLE 5

| System Bandwidth | PRG Size (P′) |
|---|---|
| (N_{RB}^{DL}) | (PRBs) |
| ≦10 | 1 |
| 11-26 | 2 |
| 27-63 | 3 |

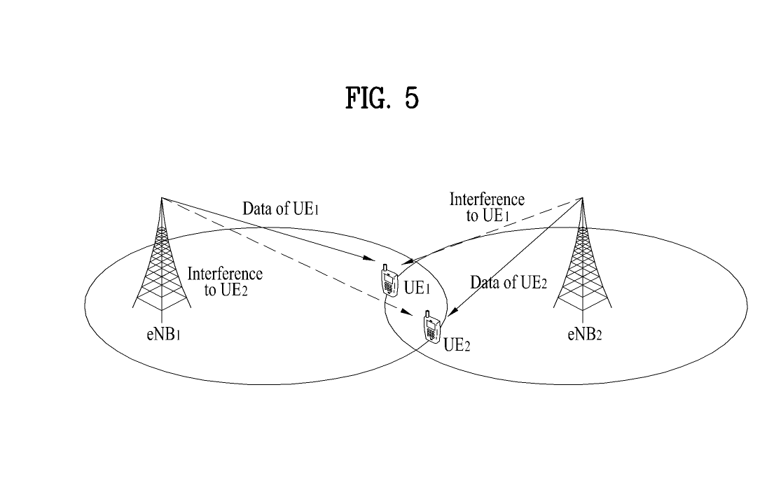

For an advanced wireless communication system such as LTE Rel-12, a Network Assisted Interference Cancellation (NAIC) scheme for cancelling interference from a neighboring cell by a UE based on the help of a network is under discussion. FIG. 5 illustrates an interference environment in which data given from eNB₁ to UE₁ provides interference to UE₂ and data given from eNB₂ to UE₂ provides interference to UE₁ when UE₁ is served by eNB₁ and UE₂ is served by eNB₂ in an LTE system. In FIG. 5, for the NAIC scheme, UE₁ or UE₂ may attempt to demodulate or decode neighboring cell data, and then cancel interference data from the received signal to mitigate interference.

In relation to the NAIC scheme of an LTE Rel-12 wireless communication system, a Symbol Level Interference Cancellation (SLIC) scheme is discussed as a representative IC scheme performed by a UE. The SLIC scheme is a scheme by which a UE detects and cancels a channel carrying a neighboring cell interference signal for each resource and interference data transmitted in the form of a complex number on the assumption of a specific modulation scheme (e.g., QPSK, 8PSK or 16QAM), and corresponds to a demodulation based neighboring cell interference cancellation scheme. The SLIC scheme achieves lower performance compared to an IC scheme for decoding and cancelling data, but provides small complexity to a UE in terms of implementation. For this reason, the SLIC scheme will be supported by future UEs having advanced receivers.

However, to perform the SLIC scheme, the UE should preliminarily obtain information about the interference signal. For example, the UE should preferentially obtain information about a resource region for transmitting the interference signal, and should further obtain information about an RS type for estimating an interference channel within the corresponding resource region, the number of Antenna Ports (APs) for transmitting corresponding RSs, an RS sequence, etc. Subsequently, the UE checks a modulation scheme applied to data to demodulate the corresponding data, and detects the value of the corresponding data based on the position of the received signal on a constellation diagram according to the corresponding modulation scheme. That is, information about a resource region for transmitting the interference signal, RS information (e.g., RS type, number of APs for RS, and RS sequence) and modulation information are necessary for SLIC. The information for SLIC may be signaled from a network to a corresponding UE, or may be directly detected by the UE through blind detection.

In this case, when the network signals the information to the corresponding UE, a signaling scheme may include a scheme for preliminarily applying semi-static coordination between data for a UE performing SLIC and interference data transmitted from a neighboring cell, a scheme for directly providing dynamic signaling from a neighboring cell to a UE performing SLIC. In terms of UE performance, compared to the semi-static coordination scheme, the scheme for dynamically signaling information about the neighboring cell interference signal from the network may be preferable due to a higher degree of freedom for UE scheduling and a low implementation complexity for blind detection. However, if the network dynamically signals all the information related to interference, e.g., information about a resource region of an interference signal, an RS type, the number of APs for RS, an RS sequence, and modulation, this can cause excessive control signal transmission load.

In this point of view, the present invention proposes a method for preferentially signaling basic information about an interference signal on the assumption that a UE performs blind detection, and providing additional information about the interference signal for a specific resource region as necessary. In relation to basic dynamic signaling for blind detection of the UE performing SLIC, an embodiment of the present invention proposes a method for signaling continuity information of a frequency resource region for an interference signal transmitted in a specific subframe. In detail, M₁ interference states I-S are defined based on characteristics of the interference signal, e.g., an RS type and a data status of the interference signal. The continuity information may be specified using M₂ transition states T-S indicating characteristic transitions of the interference signal between a specific k-th frequency resource and a previous (k−1)-th frequency resource, i.e., transition in data status, transition in precoding (e.g., including layer information), an RS type, and the same or different PDSCHs). UEs performing SLIC may autonomously detect additional information not inferable from the continuity information, e.g., the number of APs for interference data, an RS sequence and a modulation scheme, within a data region specified by the continuity information and providing interference to data of the UEs. That is, the continuity information serves to increase detection probability of the UE by providing accurate samples for detecting additional information about the interference data.

Dynamic signaling of the continuity information may be provided by a service cell for transmitting data to a UE performing SLIC, or a neighboring cell providing interference to the corresponding UE in the form of DCI in a system such as LTE-A. Additionally, the network may provide additional information necessary for SLIC about a specific region of a resource region specifiable based on the continuity information, to the UE through dynamic signaling. Although the following description of the present invention is focused on an LTE system, the operation principle of the present invention may be extendably applied to an arbitrary wireless communication system in which a UE performs an IC scheme.

According to a specific embodiment of the present invention, when a total frequency axis region of a system can be divided into L frequency resources, a description is now given of a method for defining M₁ interference characteristic states (e.g., I-S(0), I-S(1), . . . , I-S(M₁−1)) for frequency resources having no data among arbitrary frequency resources based on characteristics of an interference signal (e.g., RS type and interference data status). The present invention relates to signaling of information about a specific frequency resource region and continuity information about characteristic transitions of an interference signal between the specific frequency resource region and a neighboring frequency resource region, to UEs supporting SLIC. For brevity, a frequency resource region may be referred to as a frequency resource, and a frequency resource served as a reference or basis for the continuity information may be referred to as a previous frequency resource in this specification.

In this case, since characteristic information of an interference signal for an initial frequency resource or a frequency resource subsequent to a previous frequency resource having no data cannot be specified based on the state of the previous frequency resource, a separate specification scheme is needed. Accordingly, the present invention defines an interference state indicating a characteristic of an interference signal at an arbitrary frequency resource for transmitting the interference signal from a neighboring cell. For example, I-S states may be represented as shown in Table 6 according to an RS type and a data status in an LTE system according to an embodiment of the present invention.

TABLE 6

| | |
|---|---|
| Tx Diversity | Non Tx Diversity |

| | |
|---|---|
| No data | I-S(0) |

| | | |
|---|---|---|
| CRS based TM | I-S(1) | I-S(3) |
| DM-RS based TM | I-S(2) | — |

Table 6 shows that the LTE system largely has a CRS based transmission mode and a DM-RS based transmission mode, that a Tx diversity scheme is applicable in the CRS based transmission mode, and that interference data can be transmitted or not transmitted in a specific data region. Here, the states indicated by I-S( ) are utilized to explicitly specify some characteristics of the interference signal at the initial frequency resource or the frequency resource subsequent to a previous frequency resource having no data. That is, among characteristics of the interference signal other than the specified characteristics, information necessary to perform SLIC, e.g., information about a resource region for transmitting the interference signal, RS information (e.g., RS type, number of APs for RS, and RS sequence) and modulation information are necessary for SLIC, are subject to blind detection to be autonomously performed by the UE.

In Table 6, the Tx diversity can be considered as a kind of precoding, and thus the effectiveness thereof can be low. Instead, in some of the CRS based TMs, a distributed resource allocation scheme among a variety of resource allocation schemes of the LTE system is applied and thus signaling of information indicating different PDSCHs by slot within the same subframe may be useful. I-S states for this example may be represented as shown in Table 7.

TABLE 7

| | Same PDSCH by Slot | Different PDSCH by Slot |
|---|---|---|
| No data | I-S(0) | — |
| CRS based TM | I-S(1) | I-S(3) |
| DM-RS based TM | I-S(2) | — |

In this case, when dynamic signaling of I-S(3) of Table 7 is received for a specific frequency resource, a UE performing SLIC may not perform an NAIC scheme at the corresponding frequency resource in consideration of complexity, or a UE having sufficient hardware capability and having no problem in complexity may independently apply the NAIC scheme by slot.

According to a specific embodiment of the present invention, when a total frequency axis region of a system can be divided into L frequency resources, a description is now given of a method for defining M₂ interference transition states (e.g., T-S(0), T-S(1), . . . , T-S(M₂−1)) according to characteristic transitions of an interference signal (e.g., continuity in RS type, continuity in PDSCH and continuity in precoding) between a specific k-th frequency resource and a previous (k−1)-th frequency resource, which are specified by continuity information of the k-th frequency resource. The above continuity information proposed by the present invention is aimed to signal interference signal resource regions having the same interference characteristic so as to increase the probability that a UE supporting SLIC detects information about the interference signal, e.g., an RS sequence, the number of APs and a modulation scheme. The continuity information can be specified to specify information about the relationship between the above-defined contiguous interference states. That is, T-S may be defined as states indicating which characteristics of the interference signal are transited, e.g., continuity in RS type, continuity in PDSCH and continuity in precoding, between the k-th and (k−1)-th frequency resources. A description is now given of a method for defining interference transition states according to a specific embodiment of the present invention.

A. Case of 2 Interference Transition States

A UE performing SLIC may consider two contiguous frequency resources as one resource unit for blind detection if the two frequency resources belong to the same PDSCH. In this case, if the (k−1)-th and k-th frequency resources have data of the same PDSCH or have the same data status, the interference transition state may be defined as T-S(0). Otherwise, if the (k−1)-th and k-th frequency resources do not belong to the same PDSCH or have different data statuses, the interference transition state may be defined as T-S(1). This example is represented as shown in Table 8.

TABLE 8

| Interference characteristic between | | | Transition |
|---|---|---|---|
| (k − 1)-th and k-th frequency resource | | | state |
| Same RS type | Same Precoding | Same PDSCH | T-S(0) |
| — | — | Same Data Status | |
| — | — | Different PDSCH | T-S(1) |
| — | — | Different Data Status | |

B. Case of 3 Interference Transition States

Regions corresponding to the same precoding matrix within the same PDSCH considered in the above case A can be distinguished by, for example, PRB bundling. Accordingly, a UE performing SLIC may consider resource regions to which the same precoding matrix is applied within the same PDSCH, as one resource unit for blind detection. This example is represented as shown in Table 9.

TABLE 9

| Interference characteristic | | | Transition |
|---|---|---|---|
| between (k − 1)-th and k-th frequency resource | | | state |
| Same RS type | Same Precoding | Same PDSCH | T-S(0) |
| — | — | Same Data Status | |
| Same RS type | Different Precoding | Same PDSCH | T-S(1) |
| — | — | Different PDSCH | T-S(2) |
| — | — | Different Data Status | |

In Table 9, T-S(0) means that continuity is present in terms of RS type, PDSCH and precoding or data status between the (k−1)-th and k-th frequency resources, T-S(1) means that continuity is present in terms of RS type and PDSCH but precoding is applied differently between the (k−1)-th and k-th frequency resources, and T-S(2) means that continuity is not present in terms of PDSCH or data status between the (k−1)-th and k-th frequency resources. Accordingly, for example, when continuity information is received from the network, the UE performing SLIC may preferentially perform blind detection on an RS sequence for the same PDSCH region, and then perform additional blind detection on precoding information in every resource unit to which the same precoding matrix is applied within the same PDSCH region. As such, blind detection performance of the UE may be improved.

According to a specific embodiment of the present invention, when a total frequency axis region of a system can be divided into L frequency resources, a description is now given of a method for defining M₂ interference transition states (e.g., T-S(0), T-S(1), . . . , T-S(M₂−1)) in consideration of characteristic transitions of an interference signal (e.g., continuity in RS type, continuity in PDSCH and continuity in precoding) between a specific k-th frequency resource and a previous (k−1)-th frequency resource, which are specified by continuity information of the k-th frequency resource, together with characteristic transitions of the interference signal between the k-th frequency resource and a subsequent (k+1)-th frequency resource. If a single characteristic of the interference signal is considered in terms of continuity, the continuity can be sufficiently indicated using information about characteristic transitions of the interference signal between only 2 contiguous frequencies. However, if two or more characteristics of the interference signal, e.g., W₁ and W₂, are considered in terms of continuity, continuity in W₁ of a specific k-th frequency resource may be defined through comparison with the characteristic of W₁ at a (k−1)-th frequency resource, and continuity in W₂ may be defined through comparison with the characteristic of W₂ at a (k+1)-th frequency resource. The above-defined T-S states are represented as shown in Table 10.

TABLE 10

| Interference characteristic between (k − 1)-th and k-th | | |
|---|---|---|
| frequency resource/Interference characteristic | | Transition |
| between k-th and (k + 1)-th frequency resource | | state |
| Same Precoding/- | Same PDSCH/Same PDSCH | T-S(0) |
| Different Precoding/- | Same PDSCH/Same PDSCH | T-S(1) |
| Same Precoding/- | Same PDSCH/Different PDSCH | T-S(2) |
| Different Precoding/- | Same PDSCH/Different PDSCH | T-S(3) |

According to a specific embodiment of the present invention, when a total frequency axis region of a system can be divided into L frequency resources, a description is now given of a dynamic signaling structure in which L bit fields corresponding to the L frequency resources are configured to specify continuity information of an interference signal and a codeword (or a bit value) of each bit field indicates one of T-S states. The above continuity information proposed by the present invention assumes that a UE has sufficient blind detection capability. Thus, simply, only continuity information specified by T-S may be transmitted to the UE. In this case, the UE may obtain only information about whether a certain data region is continuous in terms of a characteristic of the interference signal. In this case, since a bit field corresponding to an initial frequency resource does not have a previous frequency resource thereof, it is assumed that a virtual previous frequency resource has one of I-S states as the characteristic of the interference signal by default. A description is now given of examples according to the T-S states defined by the present invention, and the default value is set to the case of no interference data.

A. Case of 1-Bit Field

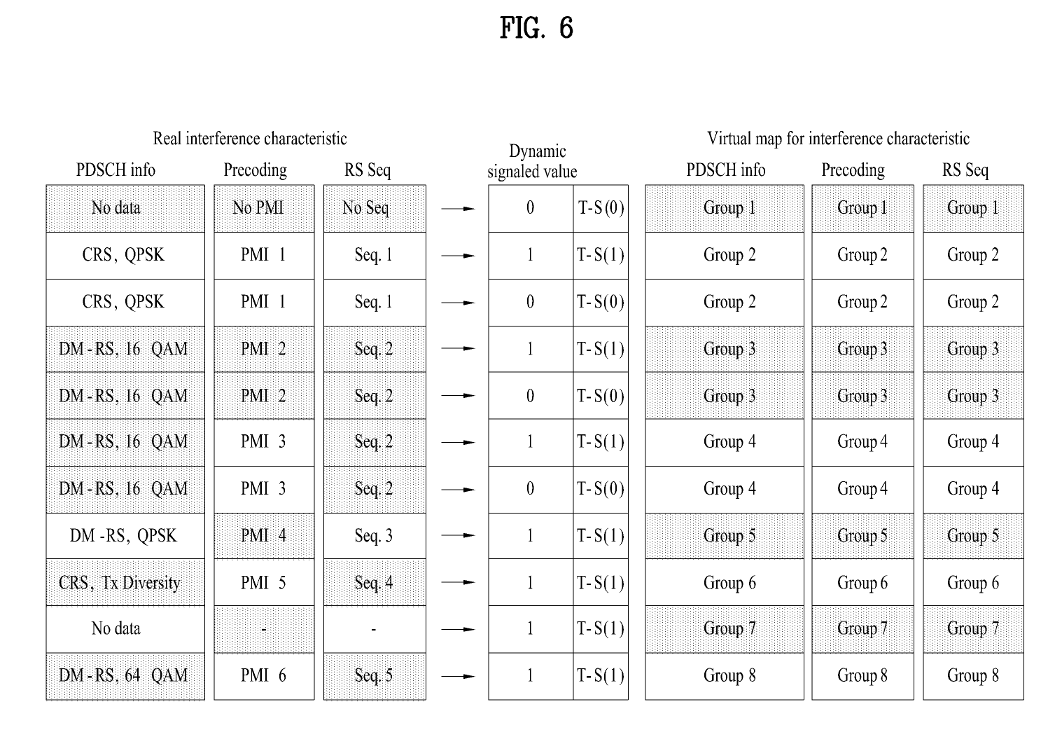

Each bit field may have 1 bit. A bit value ‘0’ may indicate T-S(0) and means that a characteristic of an interference signal (e.g., RS type, precoding, PDSCH or data status) is the same as that of a previous frequency resource, while a bit value ‘1’ means that the characteristic of the interference signal is not the same as that of the previous frequency resource. This example is represented as shown in Table 11 and FIG. 6.

TABLE 11

| k-th | | | | |
|---|---|---|---|---|
| Bits | | Interference characteristic between (k − 1)-th | | |
| fields | Indication | and k-th frequency resource | | |
| ‘0’ | T-S(0) | Same RS type | Same Precoding | Same PDSCH |
| | | — | — | Same Data Status |
| ‘1’ | T-S(1) | — | — | Different PDSCH |
| | | — | — | Different Data |
| | | | | Status |

In FIG. 6, groups classify resource regions within a specific characteristic of an interference signal. For example, groups for PDSCH information may not be the same as groups for precoding.

B. Case of 2-Bit Field

The above 1-bit field may indicate only whether contiguous frequency resources belong to the same PDSCH and transmit data to which the same precoding matrix is applied, or whether both of the contiguous frequency resources have no interference data. Accordingly, blind detection should be performed by utilizing received signals as samples within a corresponding resource unit.

However, in some cases, signaling of a resource unit of regions corresponding to different precoding matrices but the same PDSCH can be useful to a UE performing SLIC because, for example, a larger number of resource regions compared to a small number of resource regions corresponding to the same precoding matrix can be considered to perform blind detection for an RS sequence or a modulation order. Accordingly, the present invention additionally proposes dynamic signaling using bit fields indicating the T-S states based on Table 9.

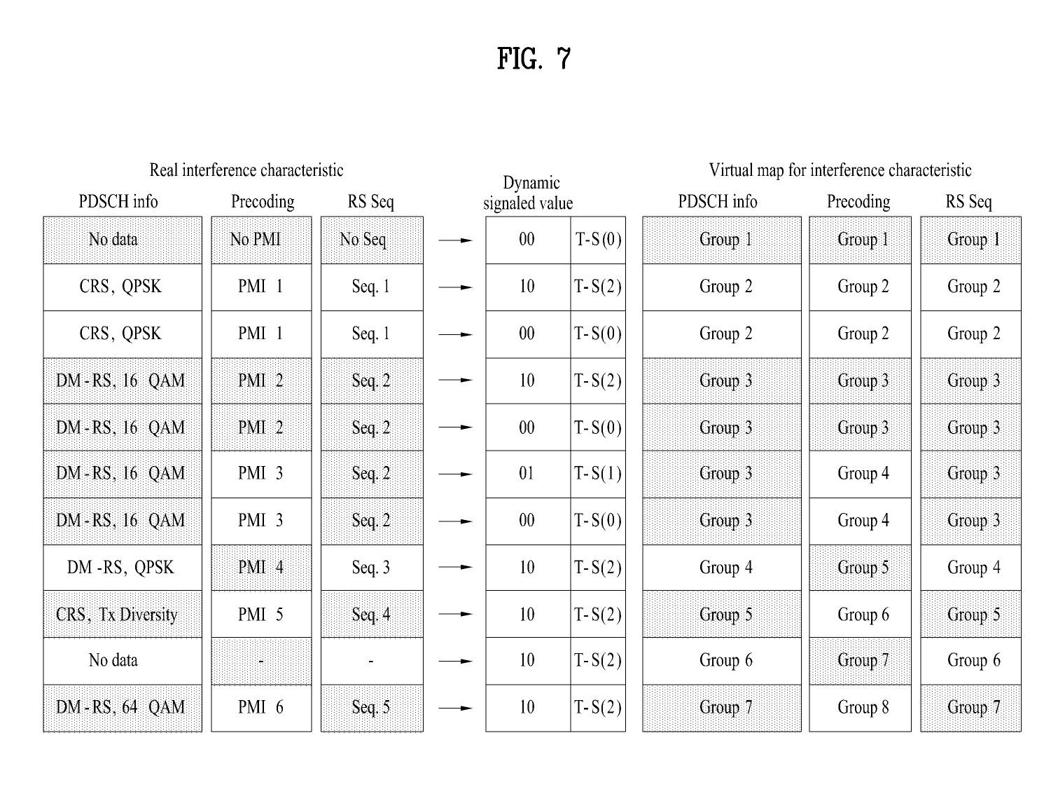

The above dynamic signaling method may be represented as shown in Table 12 and FIG. 7. In FIGS. 6 and 7, groups classify resource regions within a specific characteristic of an interference signal. Accordingly, groups for PDSCH information (whether two frequency resources belong to the same PDSCH) may not be the same as groups for precoding information (whether two frequency resources correspond to the same precoding matrix).

TABLE 12

| k-th | | Interference characteristic between | | |
|---|---|---|---|---|
| Bits | | (k − 1)-th and k-th frequency | | |
| fields | Indication | resource | | |
| ‘00’ | T-S(0) | Same RS type | Same Precoding | Same PDSCH |
| | | — | — | Same Data Status |
| ‘01’ | T-S(1) | Same RS type | Different | Same PDSCH |
| | | | Precoding | |
| ‘10’ | T-S(2) | — | — | Different PDSCH |
| | | — | — | Different Data |
| | | | | Status |
| ‘11’ | Reserved | — | — | — |

According to a specific embodiment of the present invention, when a total frequency axis region of a system can be divided into L frequency resources, a description is now given of a dynamic signaling structure in which L bit fields corresponding to the L frequency resources are configured to specify continuity information of an interference signal and a codeword (or a bit value) of each bit field indicates one of T-S states to specify continuity and indicates one of I-S states to specify discontinuity.

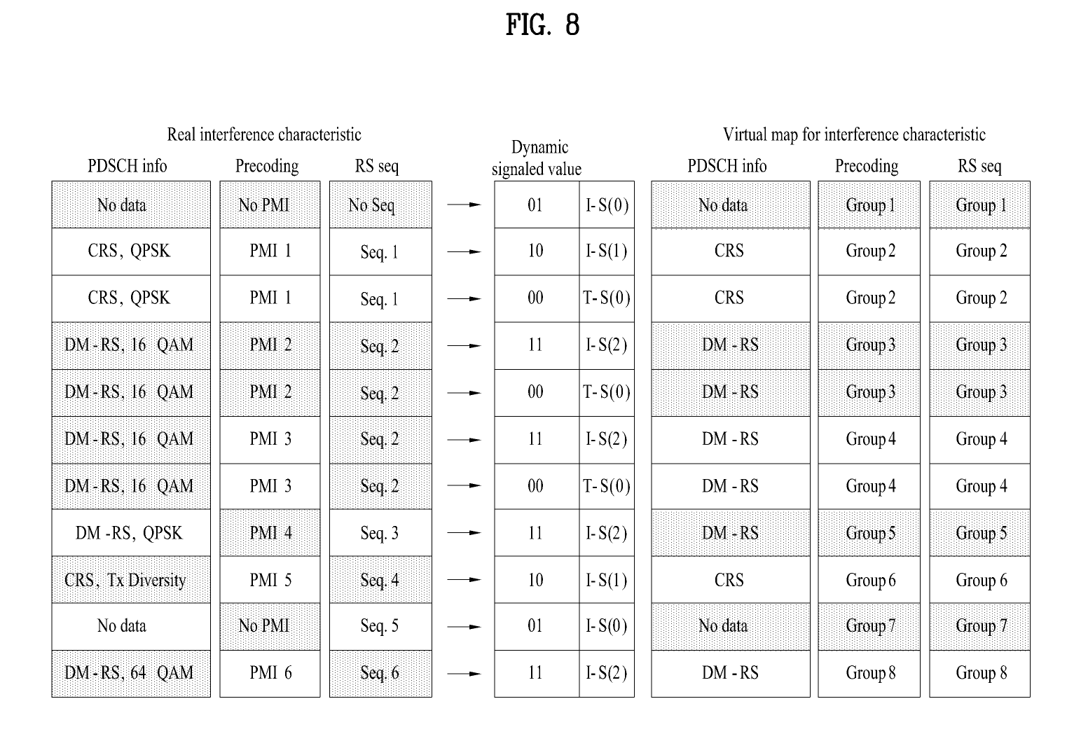

In FIGS. 6 and 7, when dynamic signaling is received, a UE performing SLIC may obtain only continuity information of regions corresponding to the same precoding matrix, RS sequence and modulation scheme for interference data. Accordingly, the current embodiment proposes a method for dynamically signaling relatively simple information, e.g., RS type and data status, together with continuity information. In detail, the current embodiment proposes a dynamic signaling method by which each bit field indicates one of T-S states to specify continuity and indicates one of I-S states not to specify continuity. This method can be interpreted as a method by which one of I-S states is used to indicate a specific interference transition for a frequency resource for which continuity is not indicated by one of T-S states. In this point of view, a dynamic signaling method using 2-bit fields indicating some of 4 I-S states (i.e., I-S(0), I-S(1), I-S(2) and I-S(3)) defined in Table 6 and T-S(0) defined in Table 8 to indicate continuity may be considered. In this case, the above dynamic signaling method uses T-S(0) indicating continuity and I-S(0), I-S(1) and I-S(2) indicating discontinuity and specific interference transition directions. The above example may be represented as shown in Table 13 and FIG. 8.

TABLE 13

| k-th | | | | |
|---|---|---|---|---|
| Bits | | Interference characteristic between (k − 1)-th | | |
| fields | Indication | and k-th frequency resource | | |
| ‘00’ | T-S(0) | Same RS type | Same Precoding | Same PDSCH |
| | | — | — | Same Data Status |

| | | |
|---|---|---|
| ‘01’ | I-S(0) | No data at k-th frequency resource |
| ‘10’ | I-S(1) | CRS based TM at k-th frequency resource |
| ‘11’ | I-S(2) | DM-RS based TM at k-th frequency resource |

Unlike the example according to FIG. 6, in the embodiment according to Table 13 and FIG. 8, 1 bit is added to each bit field for dynamic signaling and thus information about continuity in RS type is additionally providable.

As additional operation of the present invention, when a total frequency axis region of a system can be divided into L frequency resources, another example of the dynamic signaling structure in which L bit fields corresponding to the L frequency resources are configured to specify continuity information of an interference signal and a codeword (or a bit value) of each bit field indicates one of T-S states to specify continuity and indicates one of I-S states to specify discontinuity may be represented as shown in Table 14.

TABLE 14

| k-th Bits | | Interference characteristic between (k − 1)-th | | |
|---|---|---|---|---|
| fields | Indication | and k-th frequency resource | | |
| ‘00’ | T-S(0) | Same RS type | — | Same PDSCH |
| | | — | — | Same Data Status |

| | | |
|---|---|---|
| ‘01’ | I-S(0) | No data at k-th frequency resource |
| ‘10’ | I-S(1) | CRS based TM at k-th frequency resource |
| ‘11’ | I-S(2) | DM-RS based TM at k-th frequency resource |

The difference between Table 14 and Table 13 is that the continuity information indicated by T-S(0) specifies frequency resources to which the same precoding matrix is applied in Table 13, but specifies resource regions belonging to the same PDSCH in Table 14. In the case of Table 14, since minimum resource regions to which the same precoding matrix is applied can be known using precoding bundling information of neighboring cells in an LTE system according to a specific embodiment of the present invention, signaling of whether the resource regions belong to the same PDSCH may be preferable.

Interpretation of the bit field ‘00’ varies according to the interference characteristic of the (k−1)-th frequency resource. For example, if the interference characteristic of the (k−1)-th frequency resource indicates no data, the state ‘00’ is interpreted as the same data status and thus the k-th frequency resource is also interpreted as having no interference data. If the interference characteristic of the (k−1)-th frequency resource indicates a CRS or DMRS based TM, ‘00’ is interpreted as transmission of a single PDSCH through the (k−1)-th and k-th frequency resources. Since a plurality of frequency resources for transmitting a single PDSCH use the same demodulation RS type and have the same data status, ‘00’ simultaneously means the same PDSCH, the same RS type and the same data status.

If the interference characteristic of the (k−1)-th frequency resource indicates a DMRS based TM and the interference characteristic of the k-th frequency resource indicates ‘00’, an NAICS UE may check bandwidth information of an interference cell to calculate a PRB bundling size, and increase DMRS channel estimation performance of the interference cell using PRB bundling corresponding to the calculated size.

Table 15 may be considered as another embodiment of the present invention.

TABLE 15

| k-th Bits | | Interference characteristic between (k − 1)-th | | |
|---|---|---|---|---|
| fields | Indication | and k-th frequency resource | | |
| ‘00’ | T-S(0) | Same RS type | — | Same PDSCH |
| | | — | — | Same Data Status |

| | | |
|---|---|---|
| ‘01’ | I-S(0) | CRS based TM, Tx Diversity at k-th |
| | | frequency resource |
| ‘10’ | I-S(1) | CRS based TM, Non Tx Diversity at k-th |
| | | frequency resource |
| ‘11’ | I-S(2) | DM-RS based TM at k-th frequency resource |
| | | No data at k-th frequency resource |

Unlike Table 14, in Table 15, the state indicated by ‘11’ is configured to specify DM-RS based TM or no data. In this case, a UE may perform blind detection to check a data status indicating whether a k-th frequency resource corresponding to a k-th bit field having the state ‘11’ has a DM-RS. That is, a DM-RS of a neighboring cell is created to obtain correlation with a signal received in a DM-RS RE and then, if the energy of the received signal is successfully detected as a specific threshold or above, ‘11’ is interpreted as “DM-RS based TM at k-th frequency resource”. Otherwise, ‘11’ is interpreted as “No data at k-th frequency resource”. In this case, since two different interference states are indicated using one state, an extra state occurs compared to Table 14 and this extra state may be utilized to indicate Tx or non Tx diversity for a CRS based TM. Alternatively, the extra state may be configured to indicate distributed or non-distributed resource allocation (i.e., whether two slots belong to the same PDSCH) at a corresponding frequency resource for the CRS based TM as shown in Table 16.

TABLE 16

| k-th Bits | | Interference characteristic between (k − 1)-th | | |
|---|---|---|---|---|
| fields | Indication | and k-th frequency resource | | |
| ‘00’ | T-S(0) | Same RS type | — | Same PDSCH |
| | | — | — | Same Data Status |

| | | |
|---|---|---|
| ‘01’ | I-S(0) | CRS based TM, Same PDSCH (or Data Status) |
| | | by Slot at k-th frequency resource |
| ‘10’ | I-S(1) | CRS based TM, Different PDSCH (or Data |
| | | Status) by Slot at k-th frequency resource |
| ‘11’ | I-S(2) | DM-RS based TM at k-th frequency resource |
| | | No data at k-th frequency resource |

Otherwise, for a region in which a modulation order varies by slot due to distributed resource allocation or NAIC cannot be performed easily due to resource allocation on an enhanced CCE (ECCE) basis, e.g., EPDCCH, a UE may be instructed not to perform NAIC at a corresponding frequency resource. Table 17 shows an example in which a state of a bit field is utilized to instruct not to perform NAIC.

TABLE 17

| k-th Bits | | Interference characteristic between (k − 1)-th | | |
|---|---|---|---|---|
| fields | Indication | and k-th frequency resource | | |
| ‘00’ | T-S(0) | Same RS type | — | Same PDSCH |
| | | — | — | Same Data Status |

| | | |
|---|---|---|
| ‘01’ | I-S(0) | Interference cancellation is not allowed |
| ‘10’ | I-S(1) | CRS based TM at k-th frequency resource |
| ‘11’ | I-S(2) | DM-RS based TM at k-th frequency resource |
| | | No data at k-th frequency resource |

According to a specific embodiment of the present invention, when a total frequency axis region of a system can be divided into L frequency resources, a description is now given of a dynamic signaling structure in which L bit fields corresponding to the L frequency resources are configured to specify continuity information of an interference signal and a codeword (or a bit value) of an arbitrary k-th bit field is dependent on a previous (k−1)-th bit field.

Operation according to the above embodiment of the present invention is applicable if T-S states include a state indicating that an I-S state is changed after a current frequency resource. For example, in Table 6, the state I-S(0) indicates that a current frequency resource has no interference data and gives notice that a subsequent frequency resource can have interference data defined by one of new I-S states. Similarly, the states T-S(2) and T-S(3) of Table 10 give notice that a new PDSCH appears after a current frequency resource, and this gives notice that a subsequent frequency resource can have interference data defined by one of new I-S states.

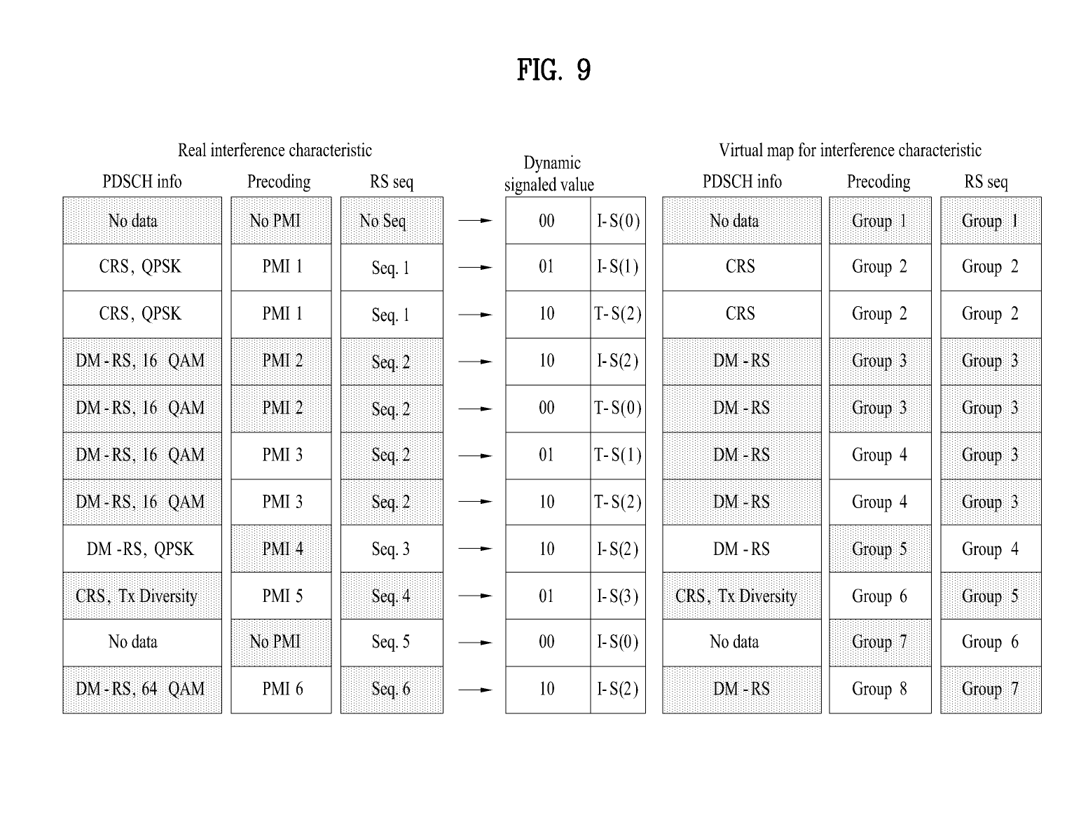

Using such characteristics, the present invention proposes a method for configuring a codeword (or a bit value) of a k-th bit field to indicate one of I-S states if a specific I-S or T-S state of a (k−1)-th bit field implies that an I-S state of a (k−1)-th frequency resource is changed at a k-th frequency resource, and configuring the corresponding k-th bit field to indicate one of T-S states otherwise. Table 18 and FIG. 9 show the above embodiment of the present invention implemented by utilizing Tables 6 and 10.

TABLE 18
(a) if (k − 1)-th bits field exists and it indicates T-S(0) or
T-S(1) or I-S(1) or I-S(2) or I-S(3)

| | | Interference characteristic between | |
|---|---|---|---|
| k-th | | (k − 1)-th and k-th frequency resource/ | |
| Bits | | Interference characteristic between | |
| fields | Indication | k-th and (k + 1)-th frequency resource | |
| ‘00’ | T-S(0) | Same Precoding/- | Same PDSCH/Same PDSCH |
| ‘01’ | T-S(1) | Different Precoding/- | Same PDSCH/Same PDSCH |
| ‘10’ | T-S(2) | Same Precoding/- | Same PDSCH/Different |
| | | | PDSCH |
| ‘11’ | T-S(3) | Different Precoding/- | Same PDSCH/Different |
| | | | PDSCH |

(b) if (k − 1)-th bits field does not exist or it indicates I-S(0) or
T-S(2) or T-S(3)

| k-th | | |
|---|---|---|
| Bits | | |
| fields | Indication | Interference characteristic at k-th frequency resource |
| ‘00’ | I-S(0) | No data |
| ‘01’ | I-S(1) | CRS based TM, Non Tx Diversity |
| ‘10’ | I-S(2) | DM-RS based TM |
| ‘11’ | I-S(3) | CRS based TM, Tx Diversity |

In Table 18, I-S(3) may be utilized as a state indicating CRS based TM and different PDSCHs by slot due to distributed resource allocation. In this case, Table 18 may be changed as shown in Table 19 according to the definition of Table 7.

TABLE 19
(a) if (k − 1)-th bits field exists and it indicates T-S(0) or T-S(1) or I-S(1)
or I-S(2) or I-S(3)

| | | Interference characteristic between | |
|---|---|---|---|
| k-th | | (k − 1)-th and k-th frequency resource/ | |
| Bits | | Interference characteristic between | |
| fields | Indication | k-th and (k + 1)-th frequency resource | |
| ‘00’ | T-S(0) | Same Precoding/- | Same PDSCH/Same PDSCH |
| ‘01’ | T-S(1) | Different Precoding/- | Same PDSCH/Same PDSCH |
| ‘10’ | T-S(2) | Same Precoding/- | Same PDSCH/Different |
| | | | PDSCH |
| ‘11’ | T-S(3) | Different Precoding/- | Same PDSCH/Different |
| | | | PDSCH |

(b) if (k − 1)-th bits field does not exist or it indicates I-S(0)
or T-S(2) or T-S(3)

| k-th | | |
|---|---|---|
| Bits | | |
| fields | Indication | Interference characteristic at k-th frequency resource |
| ‘00’ | I-S(0) | No data |
| ‘01’ | I-S(1) | CRS based TM, Same PDSCH by Slot |
| ‘10’ | I-S(2) | DM-RS based TM |
| ‘11’ | I-S(3) | CRS based TM, Different PDSCH by Slot |

Although a signal provided in the above description of the present invention carries continuity information of a frequency resource in a specific subframe, a plurality of dynamic signals carrying continuity information of time units (e.g., slot) smaller than the subframe may be provided as necessary.

According to an embodiment of the present invention, when a total frequency axis region of a system can be divided into L frequency resources and P resource regions can be configured according to whether continuity information indicates the same interference characteristic, a description is now given of a method for transmitting information about an additional characteristic of an interference signal for a specific resource region among the P resource regions from a network to UEs supporting SLIC through dynamic signaling using a predefined control signal transmission resource.

The continuity information proposed by embodiment(s) of the present invention may provide only restrictive information, e.g., continuity in RS type, interference data status and precoding, to a UE. Accordingly, the UE should additionally perform blind detection to obtain information about another characteristic of the interference signal, i.e., RS sequence, precoding and modulation. In this case, if the network has extra resources for control signal transmission, characteristic information of the interference signal not specified by the continuity information may be preferably provided through additional dynamic signaling per specific resource region. Accordingly, the present invention proposes a method for providing additional dynamic signaling from a network to a UE for P resource regions configurable according to whether continuity information indicates the same interference characteristic, and indicating a resource region corresponding to the signaled information among the P resource regions using a specific control signal transmission resource corresponding one-to-one to a Q value if the corresponding resource region is positioned at a Q-th location (Q≦P). For example, in the case of an LTE system, DCI of a Q-th resource region may indicate a specific RNTI_{Q}, and a Search Space (SS) or a CCE index and an aggregation level according to the specific RNTI_{Q} may be preconfigured such that additional DCI of the Q-th resource region at a given location may be detected.

In this case, the network may selectively provide additional dynamic signaling. For example, the network may provide additional dynamic signaling for only a resource region occupying the largest frequency resource among the resource regions divided by the continuity information.

Additionally or alternatively, the present invention proposes a method for designing the above additional dynamic signaling structure differently according to an interference characteristic of a corresponding resource region. That is, in an LTE system according to an embodiment of the present invention, if additional dynamic signaling is provided for a Q-th resource region (Q≦P) among the P resource regions, information included in additional dynamic signaling may vary according to whether the corresponding resource region is in a CRS based TM or a DM-RS based TM. For example, if additional dynamic signaling is provided for a CRS based resource region, information such as a Physical Cell ID (PCID) of a CRS sequence, a precoding matrix indicator or a modulation order may be transmitted. Otherwise, if additional dynamic signaling is provided for a DM-RS based resource region, information such as a Virtual Cell ID (VCID) of a DM-RS sequence, an indicator of a certain VCID of a VCID set preliminarily signaled, e.g., RRC signaled, to the UE, or a modulation order may be transmitted. In this case, although the length of the DCI may vary according to the above different information configurations, the UE performing SLIC may know of types of information included in additional dynamic signaling for the corresponding resource region, using the continuity information.

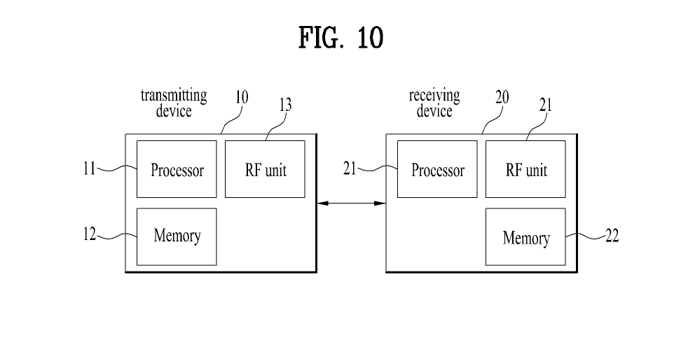

FIG. 10 is a block diagram of a transmitting device 10 and a receiving device 20 configured to implement exemplary embodiments of the present invention. Referring to FIG. 10, the transmitting device 10 and the receiving device 20 respectively include radio frequency (RF) units 13 and 23 for transmitting and receiving radio signals carrying information, data, signals, and/or messages, memories 12 and 22 for storing information related to communication in a wireless communication system, and processors 11 and 21 connected operationally to the RF units 13 and 23 and the memories 12 and 22 and configured to control the memories 12 and 22 and/or the RF units 13 and 23 so as to perform at least one of the above-described embodiments of the present invention.

The memories 12 and 22 may store programs for processing and control of the processors 11 and 21 and may temporarily storing input/output information. The memories 12 and 22 may be used as buffers. The processors 11 and 21 control the overall operation of various modules in the transmitting device 10 or the receiving device 20. The processors 11 and 21 may perform various control functions to implement the present invention. The processors 11 and 21 may be controllers, microcontrollers, microprocessors, or microcomputers. The processors 11 and 21 may be implemented by hardware, firmware, software, or a combination thereof. In a hardware configuration, Application Specific Integrated Circuits (ASICs), Digital Signal Processors (DSPs), Digital Signal Processing Devices (DSPDs), Programmable Logic Devices (PLDs), or Field Programmable Gate Arrays (FPGAs) may be included in the processors 11 and 21. If the present invention is implemented using firmware or software, firmware or software may be configured to include modules, procedures, functions, etc. performing the functions or operations of the present invention. Firmware or software configured to perform the present invention may be included in the processors 11 and 21 or stored in the memories 12 and 22 so as to be driven by the processors 11 and 21.

The processor 11 of the transmitting device 10 is scheduled from the processor 11 or a scheduler connected to the processor 11 and codes and modulates signals and/or data to be transmitted to the outside. The coded and modulated signals and/or data are transmitted to the RF unit 13. For example, the processor 11 converts a data stream to be transmitted into K layers through demultiplexing, channel coding, scrambling and modulation. The coded data stream is also referred to as a codeword and is equivalent to a transport block which is a data block provided by a MAC layer. One transport block (TB) is coded into one codeword and each codeword is transmitted to the receiving device in the form of one or more layers. For frequency up-conversion, the RF unit 13 may include an oscillator. The RF unit 13 may include Nt (where Nt is a positive integer) transmit antennas.

A signal processing process of the receiving device 20 is the reverse of the signal processing process of the transmitting device 10. Under the control of the processor 21, the RF unit 23 of the receiving device 10 receives RF signals transmitted by the transmitting device 10. The RF unit 23 may include Nr receive antennas and frequency down-converts each signal received through receive antennas into a baseband signal. The RF unit 23 may include an oscillator for frequency down-conversion. The processor 21 decodes and demodulates the radio signals received through the receive antennas and restores data that the transmitting device 10 wishes to transmit.

The RF units 13 and 23 include one or more antennas. An antenna performs a function of transmitting signals processed by the RF units 13 and 23 to the exterior or receiving radio signals from the exterior to transfer the radio signals to the RF units 13 and 23. The antenna may also be called an antenna port. Each antenna may correspond to one physical antenna or may be configured by a combination of more than one physical antenna element. A signal transmitted through each antenna cannot be decomposed by the receiving device 20. A reference signal (RS) transmitted through an antenna defines the corresponding antenna viewed from the receiving device 20 and enables the receiving device 20 to perform channel estimation for the antenna, irrespective of whether a channel is a single RF channel from one physical antenna or a composite channel from a plurality of physical antenna elements including the antenna. That is, an antenna is defined such that a channel transmitting a symbol on the antenna may be derived from the channel transmitting another symbol on the same antenna. An RF unit supporting a MIMO function of transmitting and receiving data using a plurality of antennas may be connected to two or more antennas.

In embodiments of the present invention, a UE serves as the transmission device 10 on uplink and as the receiving device 20 on downlink. In embodiments of the present invention, an eNB serves as the receiving device 20 on uplink and as the transmission device 10 on downlink.

The transmitting device and/or the receiving device may be configured as a combination of one or more embodiments of the present invention.

The detailed description of the exemplary embodiments of the present invention has been given to enable those skilled in the art to implement and practice the invention. Although the invention has been described with reference to the exemplary embodiments, those skilled in the art will appreciate that various modifications and variations can be made in the present invention without departing from the spirit or scope of the invention described in the appended claims. For example, those skilled in the art may use each construction described in the above embodiments in combination with each other. Accordingly, the invention should not be limited to the specific embodiments described herein, but should be accorded the broadest scope consistent with the principles and novel features disclosed herein.

The present invention may be used for a wireless communication apparatus such as a user equipment (UE), a relay and an eNB.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method for cancelling an interference signal using interference information in a wireless communication system, the method performed by a User Equipment (UE) and comprising:
receiving continuity information of an interference signal transmitted in a specific subframe;
estimating a characteristic of the interference signal transmitted in the specific subframe, using the continuity information; and
performing interference cancellation based on the estimated characteristic of the interference signal,
wherein the continuity information comprises interference characteristic information or interference transition information at a specific frequency resource in the specific subframe.

2. The method according to claim 1, wherein the interference characteristic information indicates characteristic of the interference signal at the specific frequency resource in the specific subframe.

3. The method according to claim 1, wherein the interference characteristic information indicates whether or not the interference signal is present, a Reference Signal (RS) type, or whether transmit diversity is used for the interference signal at the specific frequency resource in the specific subframe.

4. The method according to claim 1, wherein the interference transition information indicates information about transition in interference characteristic between two contiguous frequency resources in the specific subframe.

5. The method according to claim 1, wherein the interference transition information indicates information about whether RS types of interference signals present in two contiguous frequency resources in the specific subframe are the same, whether precoding matrices of the interference signals are the same, or whether the interference signals correspond to the same Physical Downlink Shared Channel (PDSCH).

6. The method according to claim 1, wherein, if a (k−1)-th frequency resource in the specific subframe does not have continuity information or indicates specific continuity information, the continuity information corresponding to a k-th frequency resource in the specific subframe indicates the interference characteristic information, and
wherein, if the (k−1)-th frequency resource in the specific subframe has continuity information and indicates specific continuity information, the continuity information corresponding to the k-th frequency resource in the specific subframe indicates the interference transition information.

7. The method according to claim 1, wherein the continuity information is represented using n bits to indicate one of 2ⁿ interference characteristic information states or 2ⁿ interference transition information states.

8. The method according to claim 1, further comprising receiving additional characteristic information of the interference signal in addition to the continuity information,
wherein the additional characteristic information is provided for p frequency resources determined as having the same estimated interference characteristic based on the continuity information.

9. A User Equipment (UE) configured to cancel an interference signal using interference information in a wireless communication system, the UE comprising:
a Radio Frequency (RF) unit; and
a processor configured to control the RF unit,
wherein the processor is configured to receive continuity information of an interference signal transmitted in a specific subframe, estimate a characteristic of the interference signal transmitted in the specific subframe, using the continuity information, and perform interference cancellation based on the estimated characteristic of the interference signal, and
wherein the continuity information comprises interference characteristic information or interference transition information at a specific frequency resource in the specific subframe.

10. The UE according to claim 9, wherein the interference characteristic information indicates characteristic of the interference signal at the specific frequency resource in the specific subframe.

11. The UE according to claim 9, wherein the interference characteristic information whether or not the interference signal is present, a Reference Signal (RS) type, or whether transmit diversity is used for the interference signal at the specific frequency resource in the specific subframe.

12. The UE according to claim 9, wherein the interference transition information indicates information about transition in interference characteristic between two contiguous frequency resources in the specific subframe.

13. The UE according to claim 9, wherein the interference transition information indicates information about whether RS types of interference signals present in two contiguous frequency resources in the specific subframe are the same, whether precoding matrices of the interference signals are the same, or whether the interference signals correspond to the same Physical Downlink Shared Channel (PDSCH).

14. The UE according to claim 9, wherein, if a (k−1)-th frequency resource in the specific subframe does not have continuity information or indicates specific continuity information, the continuity information corresponding to a k-th frequency resource in the specific subframe indicates the interference characteristic information, and
wherein, if the (k−1)-th frequency resource in the specific subframe has continuity information and indicates specific continuity information, the continuity information corresponding to the k-th frequency resource in the specific subframe indicates the interference transition information.

15. The UE according to claim 9, wherein the continuity information is represented using n bits to indicate one of 2ⁿ interference characteristic information states or 2ⁿ interference transition information states.

16. The UE according to claim 9, wherein the processor is further configured to receive additional characteristic information of the interference signal in addition to the continuity information, and
wherein the additional characteristic information is provided for p frequency resources determined as having the same estimated interference characteristic based on the continuity information.
